(19) United States
(12) Patent Application Publication
(10) Pub. No.: US 2025/0130589 A1
(43) Pub. Date: Apr. 24, 2025

(54) DETERMINATION OF PARAMETERS FOR SET UP OF DOCKING STATION FOR ELECTRONIC DEVICES USED IN PHOTOVOLTAIC POWER PLANTS

(71) Applicant: ACWA POWER Company, Riyadh (SA)

(72) Inventor: Omer SAROOD, Sydney (AU)

(21) Appl. No.: 18/924,733

(22) Filed: Oct. 23, 2024

Related U.S. Application Data
(60) Provisional application No. 63/592,462, filed on Oct. 23, 2023.

(51) Int. Cl. G05D 1/648; G05D 105/10; H02S 20/32; H02S 40/10

(52) U.S. Cl. CPC G05D 1/6484; H02S 20/32; H02S 40/10; G05D 2105/10

(57) ABSTRACT

A system and method for determination of parameters for the set up of docking stations for electronic devices used in photovoltaic power plants. The system obtains user input comprising a first set of parameters associated with a docking station for an electronic device from a user device. Further, the system determines a second set of parameters associated with the docking station based on the first set of parameters. Furthermore, the system renders the determined second set of parameters including a first parameter indicative of a gap between a docking station frame associated with the docking station and a module edge associated with a solar panel of the set of solar panels, a second parameter indicative of a design slope between the docking station frame and the module edge, and a third parameter indicative of a maximum angular difference between the docking station and an adjacent solar panel of a first tracker.

### CROSS-REFERENCE TO RELATED APPLICATION

This application claims priority to U.S. Provisional Patent Application Ser. No. 63/592,462, filed Oct. 23, 2023 and entitled AUTOMATIC ROBOTIC CLEANING SYSTEM FOR SOLAR PANELS, the disclosure which is incorporated herein by reference.

### TECHNOLOGICAL FIELD

The disclosure relates to the determination of parameters for the set up of a docking station, and more particularly relates to a system and a method for the determination of parameters for the set up of a docking station for electronic devices used in photovoltaic power plants.

### BACKGROUND

Solar panels, also known as photovoltaic panels, are devices that convert sunlight into electricity through the photovoltaic effect. These solar panels include multiple solar cells made of semiconductor materials, typically silicon, which absorb photons from sunlight and release electrons, thereby generating an electric current. Recently, solar panels have gained widespread popularity as a sustainable and renewable energy source offering clean energy generation with minimal environmental impact. They are being used in various applications, from residential rooftop installations to large-scale solar farms, contributing to a global transition towards greener and more environmentally friendly energy sources. However, with usage over a long time, dust, dirt, and other debris accumulate on the surface of the solar panels and block the sunlight thereby, reducing the power generation through solar panels. Therefore, regular cleaning of the solar panels is necessary to maintain optimal efficiency in areas where a loss in generation due to the soiling of panels/modules is significant enough.

Traditionally, the solar panels have been cleaned manually. However, such manual cleaning processes are tedious, time-consuming, as well as expensive. With advancements in the field of robotics, semi-automatic and fully automatic robots are also being used to clean the solar panels. With time, the cleaning of the photovoltaic panels using automatic robots has become an innovative solution to maximize energy production and efficiency. These robots are equipped with advanced sensors and cleaning mechanisms, such as brushes and wipers, to remove dust, dirt, and debris from the solar panels. By automatically cleaning the photovoltaic panels, these bots or robots enable optimal sunlight absorption and reduce the operational cost of cleaning the solar panels. Such methods are beneficial in large-scale solar installations, where manual cleaning would be labor-intensive, tedious, expensive, and almost unpragmatic. Therefore, these automatic solar photovoltaic cleaning robots or bots enhance the performance and longevity of solar panels, making them a valuable addition to the renewable energy landscape. However, these automatic robots often face challenges related to docking of these automatic robots in the solar plant, such as obstacle avoidance and path planning, which can affect their efficiency and safety.

Therefore, an improved system for the determination of parameters for the set up of docking stations for electronic devices used in photovoltaic power plants is needed for the effective movement of the automatic robots (i.e. the electronic devices).

### BRIEF SUMMARY

In order to solve the foregoing problem, the present disclosure may provide a system, a method, and a computer program product for the determination of parameters for the set up of docking stations for electronic devices used in photovoltaic power plants.

In one aspect, a system for the determination of parameters for the set up of docking stations for electronic devices used in photovoltaic power plants is disclosed. The system includes a memory to store computer-executable instructions and one or more processors coupled to the memory, the one or more processors are configured to obtain user input data including a first set of parameters associated with a docking station for an electronic device from a user device. The electronic device is used to clean a set of solar panels of a photovoltaic (PV) power plant. The one or more processors are further configured to determine a second set of parameters associated with the docking station based on the first set of parameters. The one or more processors are further configured to render the determined second set of parameters including a first parameter indicative of a gap between a docking station frame associated with the docking station and a module edge associated with a solar panel of the set of solar panels, a second parameter indicative of a design slope between the docking station frame and the module edge, and a third parameter indicative of a maximum angular difference between the docking station and an adjacent solar panel of a first tracker.

In additional system embodiments, the one or more processors are further configured to determine a set of instructions for the installation of the docking station based on the second set of parameters. The one or more processors are further configured to transmit the set of instructions to an installation device.

In additional system embodiments, the one or more processors are further configured to determine navigation instructions for the electronic device based on the second set of parameters. The navigation instructions are associated with cleaning of the set of solar panels of the PV power plant. The one or more processors are further configured to transmit the navigation instructions to the electronic device. The one or more processors are further configured to control the electronic device based on the navigation instructions.

In additional system embodiments, the electronic device includes at least one of a track-based robot, a crawler robot, a drone-based robot, a water-based robot, a dry dust removal robot, a modular cleaning robot, an automated scrubber robot, or a vacuum cleaner robot.

In additional system embodiments, the second set of parameters is determined using an application of one or more mathematical operations on the first set of parameters.

In additional system embodiments, the first set of parameters includes a first parameter indicative of the gap between the docking station frame and the module edge, a second parameter indicative of the design slope between the docking station frame and the module edge, a third parameter indicative of a maximum vertical offset of the docking station and an adjacent solar panel of the first tracker, a fourth parameter indicative of a maximum horizontal offset of the docking station and the adjacent solar panel of the first tracker, a fifth parameter indicative of a rotational angular misalignment of the first tracker at a motor level, a sixth parameter indicative of a rotational angular misalignment of the first tracker at a torque tube level, a seventh parameter indicative of a total rotational angular misalignment of the first tracker, and an eighth parameter indicative of a maximum total angular misalignment between the docking station and the adjacent solar panel of the first tracker. The first tracker associated with the PV power plant tracks the movement of the sun on one axis.

In additional system embodiments, the adjacent solar panel of the first tracker is indicative of the solar panel associated with the first tracker adjacent to the docking station.

In another aspect, a method for the determination of parameters for the set up of docking stations for electronic devices used in photovoltaic power plants is disclosed. The method includes obtaining user input including a first set of parameters associated with a docking station for an electronic device from a user device. The electronic device is used to clean a set of solar panels of a photovoltaic (PV) power plant. The method further includes determining a second set of parameters associated with the docking station based on the first set of parameters. The method further includes rendering the determined second set of parameters including a first parameter indicative of a gap between a docking station frame associated with the docking station and a module edge associated with a solar panel of the set of solar panels, a second parameter indicative of a design slope between the docking station frame and the module edge, and a third parameter indicative of a maximum angular difference between the docking station and an adjacent solar panel of a first tracker.

In additional methods, the method further includes determining a set of instructions for the installation of the docking station based on the second set of parameters. The set of instructions is associated with the installation of the docking station. The method further includes transmitting the set of instructions to an installation device.

In additional methods, the method further includes determining navigation instructions for the electronic device based on the second set of parameters. The navigation instructions are associated with cleaning of the set of solar panels of the PV power plant. The method further includes transmitting the navigation instructions to the electronic device. The method further includes controlling the electronic device based on the navigation instructions.

In additional methods, the electronic device includes at least one of a track-based robot, a crawler robot, a drone-based robot, a water-based robot, a dry dust removal robot, a modular cleaning robot, an automated scrubber robot, or a vacuum cleaner robot.

In additional methods, the second set of parameters is determined using an application of one or more mathematical operations on the first set of parameters.

In additional methods, the first set of parameters includes a first parameter indicative of the gap between the docking station frame and the module edge, a second parameter indicative of the design slope between the docking station frame and the module edge, a third parameter indicative of a maximum vertical offset of the docking station and an adjacent solar panel of the first tracker, a fourth parameter indicative of a maximum horizontal offset of the docking station and the adjacent solar panel of the first tracker, a fifth parameter indicative of a rotational angular misalignment of the first tracker at a motor level, a sixth parameter indicative of a rotational angular misalignment of the first tracker at a torque tube level, a seventh parameter indicative of a total rotational angular misalignment of the first tracker, and an eighth parameter indicative of a maximum total angular misalignment between the docking station and the adjacent solar panel of the first tracker. The first tracker associated with the PV power plant tracks the movement of the sun on one axis.

In additional methods, the adjacent solar panel of the first tracker is indicative of the solar panel associated with the first tracker adjacent to the docking station.

In yet another aspect, a non-transitory computer-readable storage medium having computer program code instructions stored therein, the computer program code instructions, when executed by one or more processors, cause the one or more processors to obtain user input data including a first set of parameters associated with a docking station for an electronic device from a user device. The electronic device is used to clean a set of solar panels of a photovoltaic (PV) power plant. The computer program code instructions, when executed by one or more processors, cause the one or more processors to determine a second set of parameters associated with the docking station based on the first set of parameters. The computer program code instructions, when executed by one or more processors, cause the one or more processors to render the determined second set of parameters including a first parameter indicative of a gap between a docking station frame associated with the docking station and a module edge associated with a solar panel of the set of solar panels, a second parameter indicative of a design slope between the docking station frame and the module edge, and a third parameter indicative of a maximum angular difference between the docking station and an adjacent solar panel of a first tracker.

In additional computer program product embodiments, the computer program code instructions, when executed by one or more processors, further cause the one or more processors to determine a set of instructions for installation of the docking station based on the second set of parameters. The set of instructions is associated with the installation of the docking station. The computer program code instructions, when executed by one or more processors, further cause the one or more processors to transmit the set of instructions to an installation device.

In additional computer program product embodiments, the computer program code instructions, when executed by one or more processors, further cause the one or more processors to determine navigation instructions for the electronic device based on the second set of parameters. The navigation instructions are associated with cleaning of the set of solar panels of the PV power plant. The computer program code instructions, when executed by one or more processors, further cause the one or more processors to transmit the navigation instructions to the electronic device. The computer program code instructions, when executed by one or more processors, further cause the one or more processors to control the electronic device based on the navigation instructions.

In additional computer program product embodiments, the electronic device includes at least one of a track-based robot, a crawler robot, a drone-based robot, a water-based robot, a dry dust removal robot, a modular cleaning robot, an automated scrubber robot, or a vacuum cleaner robot.

In additional computer program product embodiments, the second set of parameters is determined using an application of one or more mathematical operations on the first set of parameters.

In additional computer program product embodiments, the first set of parameters includes a first parameter indicative of the gap between the docking station frame and the module edge, a second parameter indicative of the design slope between the docking station frame and the module edge, a third parameter indicative of a maximum vertical offset of the docking station and an adjacent solar panel of the first tracker, a fourth parameter indicative of a maximum horizontal offset of the docking station and the adjacent solar panel of the first tracker, a fifth parameter indicative of a rotational angular misalignment of the first tracker at a motor level, a sixth parameter indicative of a rotational angular misalignment of the first tracker at a torque tube level, a seventh parameter indicative of a total rotational angular misalignment of the first tracker, and an eighth parameter indicative of a maximum total angular misalignment between the docking station and the adjacent solar panel of the first tracker. The first tracker associated with the PV power plant tracks the movement of the sun on one axis.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the disclosure in general terms, reference will now be made to the accompanying drawings, which are not necessarily drawn to scale, and wherein:

FIG. 1 illustrates an environment for the determination of parameters for the set up of docking stations for electronic devices used in photovoltaic power plants, in accordance with an embodiment of the disclosure;

FIG. 2 illustrates a block diagram of the system of FIG. 1, in accordance with an embodiment of the disclosure;

FIG. 3 illustrates exemplary operations for the determination of parameters for the set up of docking stations for electronic devices used in photovoltaic power plants, in accordance with an embodiment of the disclosure;

FIG. 4 is a diagram that illustrates a first set of parameters and a second set of parameters, in accordance with an embodiment of the disclosure;

FIG. 5 is an exemplary diagram that illustrates the second set of parameters associated with the docking station, in accordance with an embodiment of the disclosure; and

FIG. 6 illustrates a method flowchart for the determination of parameters for the set up of docking stations for electronic devices used in photovoltaic power plants, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

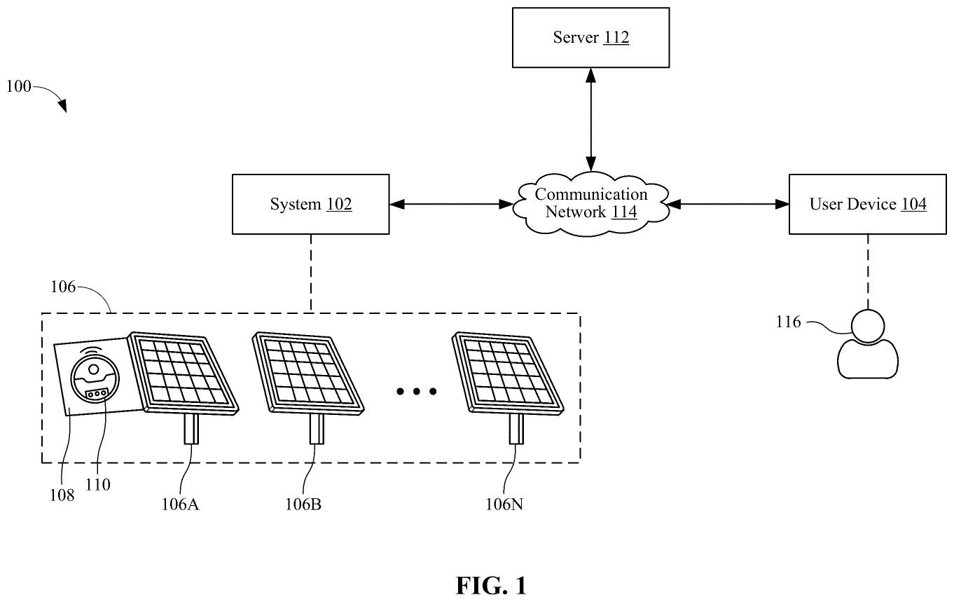

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 6, a brief description concerning the various components of the present disclosure will now be briefly discussed. Reference will be made to the figures showing various embodiments of a determination of parameters for the setup of docking stations for electronic devices used in photovoltaic power plants.

FIG. 1 illustrates an environment for a docking station installation for solar panels, in accordance with an embodiment of the disclosure. With reference to FIG. 1, there is a shown network environment 100. The network environment 100 may include a system 102, a user device 104, a photovoltaic (PV) power plant 106, a set of solar panels (such as a first solar panel 106A, a second solar panel 106B up to an Nth solar panel 106N), a docking station 108, an electronic device 110, a server 112, a communication network 114, and a user 116.

The system 102 may include suitable logic, circuitry, interfaces, and/or code that may be configured to determine a set of parameters associated with the docking station installation in the PV power plant 106. In an embodiment, the system 102 may be configured to obtain user input including a first set of parameters associated with the docking station 108 for the electronic device 110 from the user device 104. The system 102 may be configured to determine a second set of parameters associated with the docking station 108 based on the first set of parameters. The system 102 may be configured to render the determined second set of parameters including a first parameter indicative of the magnitude of a gap between a docking station frame associated with the docking station 108 and a module edge associated with a solar panel (for example the first solar panel 106A) of the set of solar panels, a second parameter indicative of magnitude of a design slope between the docking station frame and the module edge, and a third parameter indicative of magnitude of a maximum angular difference between the docking station 108 and an adjacent solar panel (for example the first solar panel 106A) of a first tracker. The first tracker may be associated with the set of solar panels of the PV power plant 106. Examples of the system 102 may include, but are not limited to, a computing device, a mainframe machine, a server, a computer workstation, a smartphone, a cellular phone, a mobile phone, a gaming device, and/or a consumer electronic (CE) device.

The user device 104 may include suitable logic, circuitry, interfaces, and/or code that may be configured to provide the user input to the system 102. The user input may include the first set of parameters associated with the docking station 108 for the electronic device 110. The user device 104 may be further configured to receive and render the second set of parameters on a display screen associated with the user device 104. Examples of the user device 104 may include, but are not limited to, a computing device, a mainframe machine, a server, a computer workstation, a smartphone, a cellular phone, a mobile phone, a gaming device, and/or a consumer electronic (CE) device.

In an embodiment, the user device 104 may be associated with the user 116. The user 116 may be an individual interacting with the system 102. In another embodiment, the user 116 may be an operator or an administrator responsible for configuring, controlling, or monitoring the PV power plant 106. The role of the user 116 may include tasks such as inputting parameters, initiating processes, or adjusting settings in the PV power plant 106 based on an output generated by the system 102, and the like.

The PV power plant 106 (also referred to as a solar power plant or solar farm or solar plant), may be a large-scale installation designed to generate electricity from sunlight using an array of solar panels (or solar arrays). Each array of solar panels (also referred to as the set of solar panels) may include one or more solar panels such as the first solar panel 106A, the second solar panel 106B, up to the Nth solar panel 106N. Each solar panel in the PV power plant 106 may be made of a semiconductor material like silicon that may convert sunlight into direct current (DC) electricity when exposed to sunlight. The generated electricity may be further converted into alternating current (AC) using one or more inverters and fed into an electrical grid or used for on-site consumption. The PV power plant 106 may vary in size from small installations on rooftops to vast utility-scale facilities covering extensive land areas, with the latter capable of producing megawatts or even gigawatts of electricity.

Each solar panel (also known as a photovoltaic (PV) panel) within the PV power plant 106 may be designed to harness sunlight and convert it into electricity. Each solar panel may include multiple solar cells made from semiconductor materials, typically silicon, which absorbs photons from sunlight and releases electrons, generating the electric current. Examples of different types of solar panels may include, but are not limited to, a monocrystalline panel, a polycrystalline panel, and a thin-film panel, each with its own efficiency and cost characteristics. For example, the monocrystalline panel may have high efficiency and may be widely used in residential installations, while the thin-film panels may offer versatility and may be often used in utility-scale solar projects due to their lower cost per watt.

The docking station 108 may be a central hub where the electronic device 110 (for example robots) may recharge, perform maintenance tasks, and receive updates. The docking station 108 may be equipped with charging ports that may align with the one or more power connectors of the electronic device 110, thereby ensuring efficient energy transfer to recharge one or more batteries of the electronic device 110. The docking station 108 may be designed to accommodate multiple electronic devices (or the robots to clean solar panels) simultaneously, thereby optimizing the cleaning schedule and ensuring that all robots are available for deployment when needed.

The docking station 108 may include diagnostic tools that may monitor the performance and health of the electronic device 110, in addition to charging the electronic device 110. The diagnostic tools may detect issues such as wear and tear on cleaning brushes, battery health, and sensor functionality. When the electronic device 110 may dock at the docking station 108, the docking station 108 may perform a quick diagnostic check and may alert the system 102 if any maintenance may be required.

The docking station 108 may also serve as a communication hub, where the electronic devices (such as the electronic device 110) may upload data collected during cleaning tasks. The data collected during the cleaning tasks may include information associated with the cleanliness of the set of solar panels, detected anomalies associated with the cleanliness of the set of solar panels, and the overall performance of the cleaning tasks. For example, the data associated with cleaning of the set of solar panels may include a percentage of the total area of the set of solar panels cleaned by the electronic device 110, a type of cleaning (if water is used in the cleaning process of the set of solar panels), a type of the brush associated with the electronic device 110 used in the cleaning process, and the like.

Furthermore, the docking station 108 may be designed to be weather-resistant, ensuring that it may operate in various environmental conditions without compromising its desired functionality. The docking station 108 may be equipped with protective covers and drainage systems to prevent water ingress and damage from dust or debris. A robust design may ensure the longevity and reliability of the docking station 108, making it a critical component in the maintenance of PV power plant 106.

The electronic device 110 may include suitable logic, circuitry, interfaces, and/or code that may be configured to perform the set of actions autonomously. The electronic device 110 may be designed to interact with its environment, execute pre-programmed actions, and make real-time decisions based on sensor inputs. The electronic device 110 may be tasked to clean each solar panel of the set of solar panels in the PV power plant 106. Specifically, the electronic device 110 may be a robot that may be configured to clean each solar panel of the set of solar panels in the PV power plant 106. In an embodiment, the electronic device 110 may be a programmable machine designed to perform a specific task autonomously or semi-autonomously. In an embodiment, the electronic device 110 may include a sensor, a power supply, a software, a communication interface, an actuator, and the like. Examples of the electronic device 110 may be, but are not limited to, a track-based robot, a crawler robot, a drone-based robot, a water-based robot, a dry dust removal robot, a modular cleaning robot, an automated scrubber robot, or a vacuum cleaner robot.

The track-based robot may use tracks or wheels to navigate across the surface of the set of solar panels and may be equipped with brushes or scrubbers to clean the set of solar panels. The track-based robot may be efficient for flat or slightly inclined surfaces. The crawler robot may use caterpillar-like tracks for movement on the set of solar panels. Specifically, the crawler robot may be designed for uneven surfaces and may be equipped with cleaning brushes or squeegees. The drone-based robot may be an aerial robot that may be equipped with cleaning mechanisms such as water sprayers or brushes and may be efficient for cleaning hard-to-reach solar panels and large installations. The water-based robot may utilize water tanks and sprayers to clean the set of solar panels. The dry dust removal robot may use air blowers or dry brushes to remove the dust and debris without using water to clean the set of solar panels. The dry dust removal robot may be suitable for arid regions where water may be scarce. The dry dust removal robot may use methods such as air pressure to clean the solar panels. The modular cleaning robot may be equipped with interchangeable cleaning modules and may allow customization for cleaning tasks such as adding brushes, squeegees, vacuum attachments, and the like. The automated scrubber robot may be designed for indoor or flat surface cleaning that may be adaptable for solar panels. The automated scrubber robot may be equipped with rotating brushes and suction mechanisms to clean the solar panels. The vacuum cleaner robot may be used to clean the solar panels that may be located indoors and may use brushes and suction to clean the set of solar panels.

The server 112 may be a specialized machine that may be designed for a specific task within the network environment 100. The server 112 may play a crucial role in responding to the system 102 request, processing data, and delivering the data efficiently. The server 112 may be designed for high-performance computing and data handling, ensuring that the system 102 requests may be handled accordingly For example, the server 112 may include but is not limited to, a mail server, a data server, an application server, or a database server.

The communication network 114 may include a communication medium through which the system 102, the user device 104, the PV power plant 106, the docking station 108, and the electronic device 110 may communicate with each other. The communication network 114 may be one of a wired connection or a wireless connection. Examples of the communication network 114 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the network environment 100 may be configured to connect to the communication network 114 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, institute of electrical and electronics engineers (IEEE) 802.11, light fidelity (Li-Fi), 802.16, IEEE 802.11s, IEEE 802.11g, multi-hop communication, wireless access point (AP), a device to device communication, cellular communication protocols, and Bluetooth (BT) communication protocols.

In operation, dirt and debris may accumulate on each solar panel in the PV power plant 106 (such as the first solar panel 106A, the second solar panel 106B, up to the Nth solar panel 106N) over a period of time due to environmental conditions. The accumulated dirt and debris may significantly impact the efficiency and overall performance of the corresponding solar panel in the PV power plant 106. The cleaning of the set of solar panels of the PV power plant 106 may be required to maintain the efficiency of the set of solar panels. For example, if the set of solar panels may be covered with a layer of dirt (for example the thickness of the layer of dirt may be 2 millimeters), then the energy-producing efficiency of the set of solar panels may be decreased by 20 percent. To maintain the energy-producing efficiency of the set of solar panels, the set of solar panels needs to be cleaned at regular intervals of time (such as every 4 hours).

For example, to clean the set of solar panels, the electronic device 110 may be configured to use a dry cleaning process (for example the electronic device 110 may clean the set of solar panels with brushes only without the use of water) for cleaning the set of solar panels. The electronic device 110 may navigate from the docking station 108 where it may be docked. The electronic device 110 may be configured to clean the set of solar panels and dock back at the docking station 108 after the successful completion of the cleaning process.

The dirt and debris may be cleaned by the electronic device 110. The electronic device 110 may be docked back at the docking station 108. For example, the electronic device 110 may be docked back at the docking station 108 for the battery recharging process of the electronic device 110, or to transmit the data associated with the cleaning of the set of solar panels to a database of the system 102. Therefore, there may be a need to set up the docking station 108.

To set up the docking station, multiple parameters associated with the setup of the docking station may have to be determined. To determine the parameters, the system 102 may be configured to obtain the user input from the user device 104. The user input may include the first set of parameters associated with the docking station 108 for the electronic device 110. The first set of parameters may include a first parameter that may be indicative of magnitude of the gap between the docking station frame and the module edge, a second parameter that may be indicative of magnitude of the design slope between the docking station frame and the module edge, a third parameter that may be indicative of magnitude of a maximum vertical offset of the docking station 108 and an adjacent solar panel of the first tracker, a fourth parameter that may be indicative of magnitude of a maximum horizontal offset of the docking station 108 and the adjacent solar panel of the first tracker, a fifth parameter that may be indicative of magnitude of a rotational angular misalignment of the first tracker at a motor level, a sixth parameter that may be indicative of magnitude of a rotational angular misalignment of the first tracker at a torque tube level, a seventh parameter that may be indicative of magnitude of a total rotational angular misalignment of the first tracker, and an eighth parameter that may be indicative of magnitude of a maximum total angular misalignment between the docking station 108 and the adjacent solar panel of the first tracker.

The first tracker associated with the PV power plant 106 tracks the movement of the sun on one axis. In an embodiment, the system 102 may be configured to determine the second set of parameters based on the first set of parameters. In an embodiment, the second set of parameters may be associated with the docking station 108. The second set of parameters may include a first parameter indicative of the magnitude of a gap between a docking station frame associated with the docking station 108 and a module edge associated with a solar panel of the set of solar panels (such as the first solar panel 106A), a second parameter indicative of a magnitude of a design slope between the docking station frame and the module edge, and a third parameter indicative of a magnitude of a maximum angular difference between the docking station 108 and an adjacent solar panel of a first tracker. The adjacent solar panel of the first tracker may be indicative of a solar panel (such as the first solar panel 106A) associated with the first tracker adjacent to the docking station 108. In an embodiment, the system 102 may be configured to render the determined second set of parameters on the user device 104 associated with user 116.

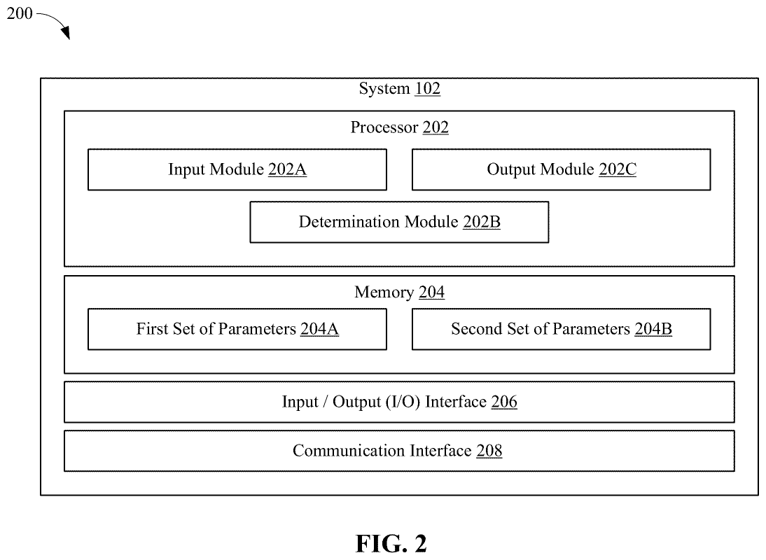

FIG. 2 illustrates a block diagram 200 of the system 102 of FIG. 1, in accordance with an embodiment of the disclosure. FIG. 2 is explained in conjunction with FIG. 1. In FIG. 2, there is shown the block diagram 200 of the system 102. The system 102 may include one or more processors (referred to as a processor 202, hereinafter), a memory 204, an input/output (I/O) interface 206, and a communication interface 208. The processor 202 may be coupled to the memory 204, the I/O interface 206, and the communication interface 208. The processor 202 may include an input module 202A, a determination module 202B, and an output module 202C. The processor 202 may retrieve computer program code instructions that may be stored in the memory 204 for execution of the computer program code instructions. The memory 204 may store data including a first set of parameters 204A, and a second set of parameters 204B. Although in FIG. 2, it is shown that the system 102 includes the processor 202, the memory 204, the I/O interface 206, and the communication interface 208, however, the disclosure may not be so limiting and the system 102 may include fewer or more components to perform the same or other functions of the system 102.

The processor 202 may comprise suitable logic, circuitry, and interfaces that may be configured to execute instructions stored in the memory 204. The executed instructions may correspond to a reception of the user input, the determination of the second set of parameters, and the rendering of the determined second set of parameters. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment, such as 100 may be accessed using the communication interface 208 of the system 102. The communication interface 208 may provide an interface for accessing various features and data stored in the system 102.

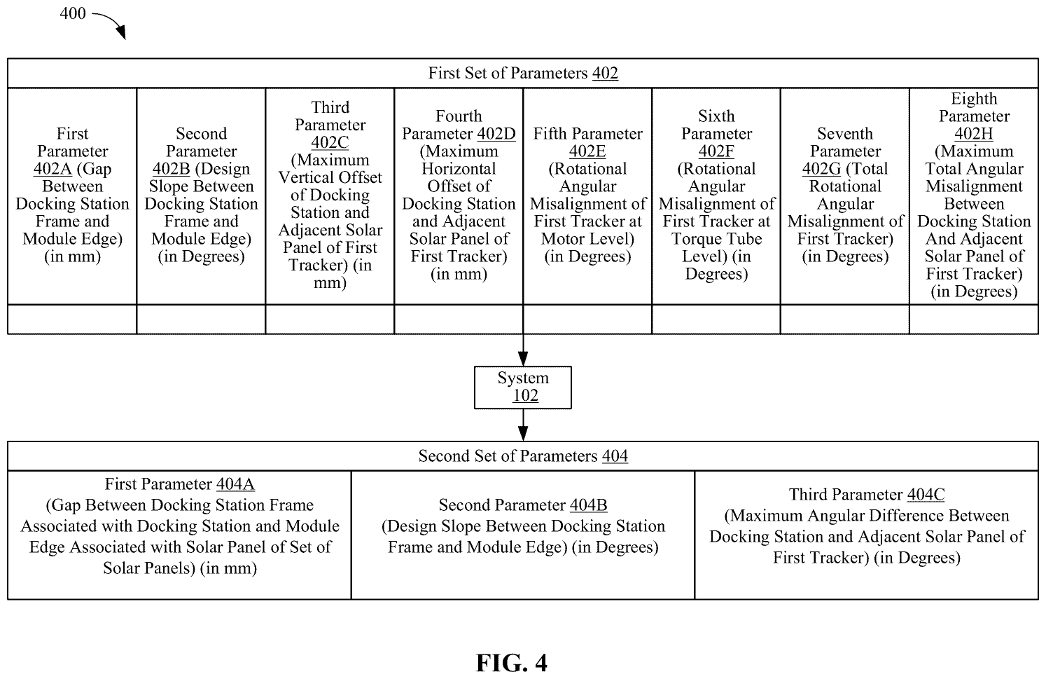

In an embodiment, the input module 202A of the processor 202 may be configured to obtain the user input. The user input may be obtained from the user device 104 and may include the first set of parameters 204A associated with the docking station 108 for the electronic device 110. The electronic device 110 may be used to clean the set of solar panels (such as the first solar panel 106A, the second solar panel 106B, up to the Nth solar panel 106N) of the PV power plant 106. Details about the first set of parameters 204A are provided, for example, in FIG. 4.

The determination module 202B of the processor 202 may be configured to determine the second set of parameters 204B. The second set of parameters 204B may be determined based on the first set of parameters 204A. The second set of parameters 204B may be associated with the docking station 108 and may include a first parameter indicative of a gap between a docking station frame associated with the docking station and a module edge associated with a solar panel of the set of solar panels, a second parameter indicative of a design slope between the docking station frame and the module edge, and a third parameter indicative of a maximum angular difference between the docking station and an adjacent solar panel of a first tracker. For example, the system 102 may determine the second set of parameters 204B associated with the docking station 108 based on the first set of parameters 204A. Details about the second set of parameters 204B are provided, for example, in FIG. 4.

The output module 202C of the processor 202 may be configured to render the determined second set of parameters 204B. In an embodiment, the output module 202C may be configured to render the second set of parameters on the user device 104. The second set of parameters 204B may include the first parameter indicative of magnitude of the gap between the docking station frame associated with the docking station 108 and the module edge associated with the solar panel of the set of solar panels (such as the first solar panel 106A, the second solar panel 106B, up to the Nth solar panel 106N), the second parameter indicative of magnitude of the design slope between the docking station frame and the module edge, and the third parameter indicative of magnitude of the maximum angular difference between the docking station 108 and the adjacent solar panel of the first tracker. In an example, the system 102 may render the determined second set of parameters 204B on a user interface (UI) of the user device 104.

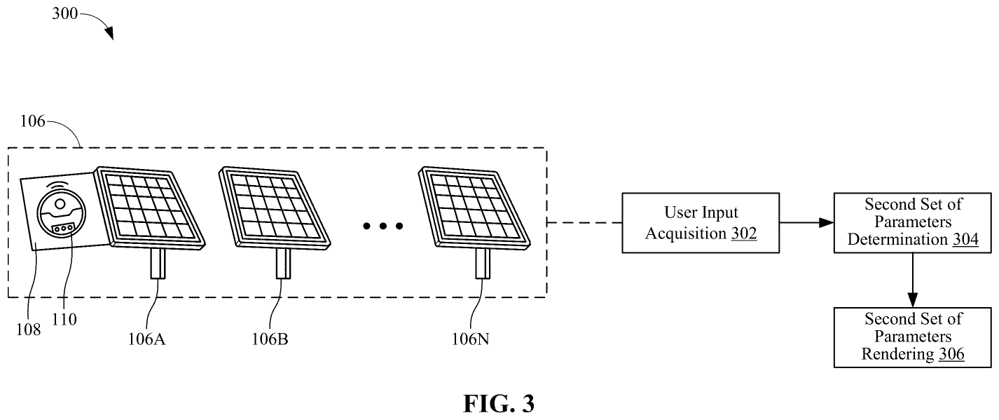

In an embodiment, the second set of parameters 204B may be rendered to determine a set of instructions for the installation of the docking station 108 based on the second set of parameters 204B. The set of instructions may be associated with the installation of the docking station 108. The set of instructions may be further transmitted to an installation device. Details about the installation device and the set of instructions are provided, for example, at 306 in FIG. 3.

In an alternate embodiment, the second set of parameters 204B may be rendered to determine navigation instructions for the electronic device 110 based on the second set of parameters 204B. The navigation instructions may be associated with the navigation of the electronic device 110 for cleaning the set of solar panels. The set of instructions may be transmitted to the electronic device 110. The system 102 may control the electronic device 110 based on the navigation instructions. Details about the navigation instructions are provided, for example, at 306 in FIG. 3.

The memory 204 may include suitable logic, circuitry, and/or interfaces that may be configured to store the program instructions executable by the processor 202. The memory 204 may store the received first set of parameters 204A and the determined second set of parameters 204B. The memory 204 may be non-transitory and may include, for example, one or more volatile and/or non-volatile memories. In other words, for example, the memory 204 may be an electronic storage device (for example, a computer-readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA, or the like, the processor 202 may be specifically configured hardware for conducting the operations described herein.

The I/O interface 206 may comprise suitable logic, circuitry, and/or interfaces that may be configured to act as an I/O channel/interface between the user 116 and the system 102. The I/O interface 206 may be configured to receive the user input. In some embodiments, the I/O interface 206 may be configured to render the second set of parameters. The I/O interface 206 may comprise various input and output devices, which may be configured to communicate with different operational components of the system 102. Examples of the I/O interface 206 may include, but are not limited to, a touch screen, a keyboard, a mouse, a joystick, a microphone, and a display screen.

The communication interface 208 may comprise the input interface and output interface for supporting communications to and from the system 102, the user device 104, or any other component with which the system 102 may communicate. The communication interface 208 may be any means such as a device or circuitry embodied in either hardware or a combination of hardware and software that is configured to receive and/or transmit data to/from a communications device in communication with the system 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms.

FIG. 3 illustrates exemplary operations for the determination of parameters for the set up of docking stations for electronic devices used in PV power plants, in accordance with an embodiment of the disclosure. FIG. 3 is explained in conjunction with elements from FIG. 1 and FIG. 2. With reference to FIG. 3, there is shown a block diagram 300 that illustrates exemplary operations from 302 to 306, as described herein. The exemplary operations illustrated in the block diagram 300 may start at 302 and may be performed by any computing system, apparatus, or device, such as by the system 102 of FIG. 1. Although illustrated with discrete blocks, the exemplary operations associated with one or more blocks of the block diagram 300 may be divided into additional blocks, combined into fewer blocks, or skipped, depending on the implementation.

At 302, a user input acquisition operation may be executed. In the user input acquisition operation, the system 102 may be configured to obtain the user input from the user device 104. The user input may include the first set of parameters 204A associated with the docking station 108 for the electronic device 110. The first set of parameters 204A may include the first parameter indicative of magnitude of the gap between the docking station frame and the module edge, the second parameter indicative of magnitude of the design slope between the docking station frame and the module edge, the third parameter indicative of magnitude of the maximum vertical offset of the docking station 108 and the adjacent solar panel of the first tracker, the fourth parameter indicative of magnitude of the maximum horizontal offset of the docking station 108 and the adjacent solar panel of the first tracker, the fifth parameter indicative of magnitude of a rotational angular misalignment of the first tracker at a motor level, the sixth parameter indicative of magnitude of a rotational angular misalignment of the first tracker at a torque tube level, the seventh parameter indicative of magnitude of a total rotational angular misalignment of the first tracker, and the eighth parameter indicative of magnitude of a maximum total angular misalignment between the docking station 108 and the adjacent solar panel of the first tracker. The first tracker associated with the PV power plant 106 tracks the movement of the sun on one axis. In an embodiment, the user input may be obtained from measurement sensors (such as light detection and ranging (LIDAR) sensors, inertial measurement unit (IMU) sensors, and the like) associated with the user device 104. Details about the first set of parameters 204A are provided, for example, in FIG. 4.

In an embodiment, the electronic device 110 may be used to clean the set of solar panels (such as the first solar panel 106A, the second solar panel 106B, up to the Nth solar panel 106N) of the PV power plant 106. As previously discussed, the electronic device 110 may be at least one of the track-based robots, the crawler robot, the drone-based robot, the water-based robot, the dry dust removal robot, the modular cleaning robot, the automated scrubber robot, or the vacuum cleaner robot.

At 304, a second set of parameters determination operation may be executed. In the second set of parameters determination operation, the system 102 may be configured to determine the second set of parameters 204B based on the first set of parameters 204A. The second set of parameters 204B may be associated with the docking station 108. In an embodiment, the second set of parameters 204B may be determined using an application of one or more mathematical operations on the first set of parameters 204A. In an embodiment, the one or more mathematical operations may include operations such as an addition operation, a subtraction operation, a multiplication operation, a division operation, and the like.

At 306, a second set of parameters rendering operation may be executed. In the second set of parameters rendering operation, the system 102 may be configured to render the second set of parameters 204B. The second set of parameters 204B may include the first parameter indicative of the magnitude of the gap between the docking station frame associated with the docking station 108 and the module edge associated with the solar panel (such as the first solar panel 106A) of the set of solar panels, the second parameter indicative of magnitude of the design slope between the docking station frame and the module edge, and the third parameter indicative of magnitude of the maximum angular difference between the docking station 108 and the adjacent solar panel (such as the first solar panel 106A) of the first tracker. The docking station frame may be the outer edge of the docking station 108 adjacent to the first solar panel 106A. The module edge may be the outer edge of the first solar panel 106A adjacent to the docking station 108. The design slope between the docking station frame and the module edge may be indicative of an inclination or an angle between the docking station 108 and at least one solar panel of the set of solar panels of the PV power plant 106. The at least one solar panel of the set of solar panels may be the solar panel that may be adjacent to the docking station 108 (for example, the first solar panel 106A). The adjacent solar panel of the first tracker may be the solar panel associated with the first tracker adjacent to the docking station 108.

In an embodiment, the system 102 may be configured to determine a set of instructions for installation of the docking station 108 based on the second set of parameters 204B. The set of instructions may be associated with the installation of the docking station 108. Specifically, the set of instructions may correspond to a set of commands that may be processed by the system 102 for a specific task (for example installation of the docking station 108). The set of instructions may include for example an angle of installation of the docking station 108 with respect to the ground level, a medium of connection between the docking station 108 and the first solar panel 106A (such as connecting the docking station 108 and the first solar panel 106A by welding, screws, and the like), and the like. In an embodiment, the system 102 may be configured to transmit the set of instructions to an installation device. In an embodiment, the installation device may be a tool, equipment, or an apparatus that may be designed for the installation of a specific system (for example, the installation device may be designed for the installation of the docking station 108). In an example, the installation device may be used to install the docking station 108 based on the second set of parameters 204B.

The installation device may be a laser alignment tool, a digital protractor, a mounting template, and the like. The laser alignment tool may use lasers to project horizontal or vertical laser lines across installation areas to precisely align the docking station 108. The laser alignment tool may use the lasers to measure distances to ensure efficient placement and alignment of the docking station 108. For example, the docking station 108 may be installed using the laser alignment tool. The laser alignment tool may be placed at the extreme end of the set of solar panels. The docking station 108 may be installed on the opposite extreme end of the set of solar panels with respect to the laser alignment tool. The laser alignment tool may use lasers to align the docking station 108 with the set of solar panels. The accurate installation of the docking station 108 aligned with the set of solar panels may ensure a straight and symmetric pathway for the electronic device 110 to clean the set of solar panels.

The digital protractor may provide precise angle measurements to ensure the docking station 108 may be mounted at a specific angle. The digital protractor may set precise angles for accurate positioning of the docking station 108. For example, the angle of installation of the docking station 108 may be determined as 43.2 degrees anticlockwise from the ground level. In that case, the digital protractor may be used to install the docking station 108 at the specified angle. The digital protractor may determine the precise angle for precise installation of the docking station 108 with a ‘0.1’ degree accuracy. The mounting template may be a pre-marked template that may help to position the mounting hardware accurately based on a pre-determined set of measurement values (such as the first set of parameters 204A). The mounting hardware may be associated with the docking station 108. For example, the mounting template for the docking station 108 may be used to install the docking station 108. The mounting template may be made based on the first set of parameters 204A associated with the docking station 108. The mounting template may be a steel frame on which the docking station 108 may be directly installed. The steel frame may be specifically designed for the docking station 108 (such as the point of installation on the steel frame may be designed as per the determined angle of installation of the docking station 108).

In an embodiment, the system 102 may be configured to determine navigation instructions for the electronic device 110 based on the second set of parameters 204B. The navigation instructions may be associated with the navigation of the electronic device 110 for cleaning the set of solar panels of the PV power plant 106. In an embodiment, the system 102 may be configured to transmit the navigation instructions to the electronic device 110. The system 102 may be further configured to control the electronic device 110 based on the navigation instructions. The navigation instructions may include instructions for the electronic device 110 to return to the docking station 108, instructions for the electronic device 110 to leave the docking station 108, instructions for the electronic device 110 to retry navigation in case the electronic device 110 cannot find the docking station 108, instructions for the electronic device 110 to clean the set of solar panels and dock back at the docking station 108, instructions for the electronic device 110 to clean the set of solar panels multiple times (for example, the electronic device 110 may clean the set of solar panels 3 times back and forth), instructions for the electronic device 110 to start cleaning the set of solar panels from the solar panel adjacent to the docking station 108, instructions for the electronic device 110 to start cleaning the set of solar panels at the extreme end opposite to the solar panel adjacent to the docking station 108 and end the cleaning at the solar panel adjacent to the docking station 108 (for example, a dirt collector may be installed at the edge of the solar panel adjacent to the docking station 108 that may collected the dirt and debris cleaned from the set of solar panels), and the like.

FIG. 4 is a block diagram that illustrates a first set of parameters 402 and a second set of parameters 404 for the determination of parameters for the set up of docking stations for electronic devices used in photovoltaic power plants, in accordance with an embodiment of the disclosure. FIG. 4 is explained in conjunction with elements from FIG. 1, FIG. 2, and FIG. 3. With reference to FIG. 4, there is shown a block diagram 400. There is further shown the first set of parameters 402 and the second set of parameters 420. The first set of parameters 402 may be indicative of the user input obtained from the user device 104 associated with the docking station 108. With reference to FIG. 4, there is further shown the system 102. There is further shown the second set of parameters 420. The second set of parameters 404 may be indicative of the parameters that may be determined for the setup of the docking station 108 for the electronic device 110 used in the PV power plant 106. In an embodiment, the system 102 may be configured to render the second set of parameters 404 associated with the docking station 108 based on the received first set of parameters 402. The first set of parameters 402 is an exemplary embodiment of the first set of parameters 204A of FIG. 2. The second set of parameters 404 is an exemplary embodiment of the second set of parameters 204B of FIG. 2.

As previously discussed, the set of solar panels (the first solar panel 106A, the second solar panel 106B, up to the Nth solar panel 106N) may be PV devices that may generate electricity from the sunlight. In an embodiment, the electronic device 110 may be used to clean the set of solar panels as they may access difficult-to-reach areas and may provide an accessible and economical implementation. Further, after the cleaning of the set of solar panels, optimal absorption of sunlight may be ensured, thereby amplifying energy production and reducing maintenance costs.

However, building automatic robots for solar panel cleaning (such as the electronic device 110) often necessitates an incorporation of docking stations (such as the docking station 108). In an embodiment, the docking station 108 may refer to a specialized location where the electronic device 110 may be stationed for a plurality of maintenance and operational tasks. The plurality of maintenance and operational tasks may include servicing the electronic device 110 at the docking station 108, charging the electronic device 110 at the docking station 108, transmitting cleaning data of the set of solar panels from the electronic device 110 to the database of the system 102, software updates for the electronic device 110 at the docking station 108, and the like. In an embodiment, the docking station 108 may serve as a base point for the electronic device 110.

In an embodiment, the docking station 108 may serve as a charging source for the electronic device 110. The electronic device 110 may navigate to the docking station 108, in case the battery charge of the electronic device 110 is low, the electronic device 110 may navigate towards the docking station 108 to recharge the battery to ensure the electronic device 110 remains operational for an extended period of time (such as 30 minutes, 1 hour, 5 hours, and the like) with or without human intervention.

Further, in order to determine an efficient and effective setup of the docking station 108 with the set of solar panels, the system 102 may determine the second set of parameters 404 associated with the docking station 108 based on the first set of parameters 402. The first set of parameters 402 and the second set of parameters 404 may be associated with the docking station 108.

In an embodiment, the first set of parameters 402 may include a first parameter 402A indicative of the magnitude of the gap between the docking station frame associated with the docking station 108 and the module edge associated with the solar panel (such as the first solar panel 106A) of the set of solar panels. The docking station frame may be the outer edge of the docking station 108 adjacent to the first solar panel 106A. The module edge may be the outer edge of the first solar panel 106A adjacent to the docking station 108. The gap between the docking station frame and the module edge may be indicative of a perpendicular distance between the docking station frame of the docking station 108 and the outer edge of the first solar panel 106A of the PV power plant 106. In an embodiment, the first parameter 402A may be measured in millimeters. For example, the first parameter 402A is ‘500’ millimeters between the docking station frame of the docking station 108 and the module edge of the first solar panel 106A.

In an embodiment, the first set of parameters 402 may include a second parameter 402B indicative of the magnitude of the design slope between the docking station frame and the module edge. The design slope between the docking station frame and the module edge may be indicative of an inclination or an angle between the docking station 108 and at least one solar panel of the set of solar panels of the PV power plant 106. The at least one solar panel of the set of solar panels may be the solar panel that may be adjacent to the docking station 108 (for example, the first solar panel 106A). In an embodiment, the second parameter 402B may be measured in degrees. For example, the second parameter 402B is ‘30’ degrees anticlockwise to the horizontal level between the docking station frame of the docking station 108 and the module edge of the first solar panel 106A.

In an embodiment, the first set of parameters 402 may include a third parameter 402C indicative of a magnitude of the maximum vertical offset of the docking station 108 and the adjacent solar panel of the first tracker. The maximum vertical offset of the docking station 108 and the adjacent solar panel of the first tracker may be indicative of the maximum permissible vertical displacement between the docking station 108 and the adjacent solar panel of the first tracker. In an embodiment, the third parameter 402C may be measured in millimeters. For example, the third parameter 402C is ‘450’ millimeters between the docking station 108 and the first solar panel 106A.

In an embodiment, the first set of parameters 402 may include a fourth parameter 402D indicative of a magnitude of the maximum horizontal offset of the docking station 108 and the adjacent solar panel of the first tracker. The maximum horizontal offset of the docking station 108 and the adjacent solar panel of the first tracker may be indicative of the maximum permissible horizontal displacement between the docking station 108 and the adjacent solar panel of the first tracker. In an embodiment, the fourth parameter 402D may be measured in millimeters. For example, the fourth parameter 402D is ‘400’ millimeters between the docking station 108 and the first solar panel 106A.

In an embodiment, the first set of parameters 402 may include a fifth parameter 402E indicative of the magnitude of the rotational angular misalignment of the first tracker at the motor level. The rotational angular misalignment of the first tracker at the motor level may be indicative of a degree of angular deviation between an intended or a desired orientation of the first tracker and its default position (for example, 45 degrees from ground level). The motor level may indicate the surface level at which the motor of the set of solar panels may be present. The motor may be responsible for rotating the torque tube in a pre-defined axis of rotation based on the position of the sun. The fifth parameter 402E may be crucial in solar tracking systems which may be designed to follow the path of the sun to maximize energy capture efficiency. The first tracker associated with the PV power plant 106 may track the movement of the sun on one axis. In an embodiment, the fifth parameter 402E may be obtained from the supplier of the first tracker. In an embodiment, the fifth parameter 402E may be measured in degrees. For example, the fifth parameter 402E is ‘40’ degrees anticlockwise to the horizontal level.

In an embodiment, the first set of parameters 402 may include a sixth parameter 402F indicative of the magnitude of the rotational angular misalignment of the first tracker at the torque tube level. The rotational angular misalignment of the first tracker at the torque tube level may be indicative of the extent of an angular deviation between the intended position of the first tracker and its default position (for example, 30 degrees from the ground level), specifically at the level of torque tubes. The torque tube level may be the surface level at which the torque tube of the set of solar panels may be present. The torque tube may be a rotating tube on which the set of solar panels may be installed. The set of solar panels is rotated based on the rotation of the torque tube. The rotation of the torque tube may be powered by the motor. In an embodiment, the sixth parameter 402F may be obtained from a supplier of the first tracker. In an embodiment, the sixth parameter 402F may be measured in degrees. For example, the sixth parameter 402F is ‘45’ degrees anticlockwise to the horizontal level.

In an embodiment, the first set of parameters 402 may include a seventh parameter 402G indicative of a magnitude of the total rotational angular misalignment of the first tracker. The seventh parameter may be determined by applying a sum operation on the fifth parameter and the sixth parameter. The total rotational angular misalignment of the first tracker may be indicative of the sum of the rotational angular misalignment of the first tracker at the motor level and the rotational angular misalignment of the first tracker at the torque tube level. In an embodiment, the total rotational angular misalignment may be determined to set up the docking station 108 for the electronic device 110 irrespective of an angular misalignment present in the first tracker. In an embodiment, the seventh parameter 402G may be measured in degrees. For example, the seventh parameter 402G is ‘50’ degrees anticlockwise to the horizontal level.

In an embodiment, the first set of parameters 402 may include an eighth parameter 402H indicative of a magnitude of the maximum total angular misalignment between the docking station 108 and the adjacent solar panel of the first tracker (for example, the first solar panel 106A). The maximum total angular misalignment between the docking station 108 and the adjacent solar panel of the first tracker may be indicative of a maximum allowable angular misalignment between the docking station 108 and the adjacent solar panel of the first tracker. The adjacent solar panel may be mounted on the first tracker within the PV power plant 106. In an embodiment, the eighth parameter 402H may be measured in degrees. For example, the eighth parameter 402H is ‘55’ degrees anticlockwise to the horizontal level.

In an embodiment, the system 102 may determine the second set of parameters 404 based on the first set of parameters 402 obtained from the user device 104. In an embodiment, the second set of parameters 404 may include a first parameter 404A indicative of the magnitude of the gap between the docking station frame and the module edge. The docking station frame may be the outer edge of the docking station 108 adjacent to the first solar panel 106A. The module edge may be the outer edge of the first solar panel 106A adjacent to the docking station 108. The gap between the docking station frame and the module edge may be indicative of the perpendicular distance between the docking station frame of the docking station 108 and the outer edge of the first solar panel of the PV power plant 106. In an embodiment, the system 102 may be configured to determine a proposed value for the gap between the docking station frame and the module edge based on the first parameter 402A of the first set of parameters 402. In an embodiment, the first parameter 404A may be measured in millimeters. For example, the first parameter 404A is ‘550’ millimeters between the docking station frame of the docking station 108 and the module edge of the first solar panel 106A.

In an embodiment, the second set of parameters 404 may include a second parameter 404B indicative of the magnitude of the design slope between the docking station frame and the module edge. The design slope between the docking station frame and the module edge may be indicative of an inclination or an angle between the docking station 108 and at least one solar panel of the set of solar panels of the PV power plant 106. The at least one solar panel of the set of solar panels may be the solar panel adjacent to the docking station 108 (for example, the first solar panel 106A). In an embodiment, the system 102 may be configured to determine a proposed value for the design slope between the docking station frame and the module edge based on the second parameter 402B of the first set of parameters 402. In an embodiment, the second parameter 402B may be measured in millimeters. For example, the second parameter 402B is ‘550’ millimeters between the docking station frame of the docking station 108 and the module edge of the first solar panel 106A.

In an embodiment, the second set of parameters 404 may include a third parameter 404C indicative of a magnitude of the maximum angular difference between the docking station 108 and the adjacent solar panel of the first tracker. The maximum angular difference between the docking station 108 and the adjacent solar panel of the first tracker may be indicative of a maximum allowable angular variation between the docking station 108 and the adjacent solar panel. The adjacent solar panel may be mounted on the first tracker within the PV power plant 106. In an embodiment, the adjacent solar panel may be the first solar panel 106A. In an embodiment, the third parameter 404C may be measured in degrees. For example, the third parameter 404C is ‘20’ degrees anticlockwise to the horizontal level between the docking station 108 and the first solar panel 106A.

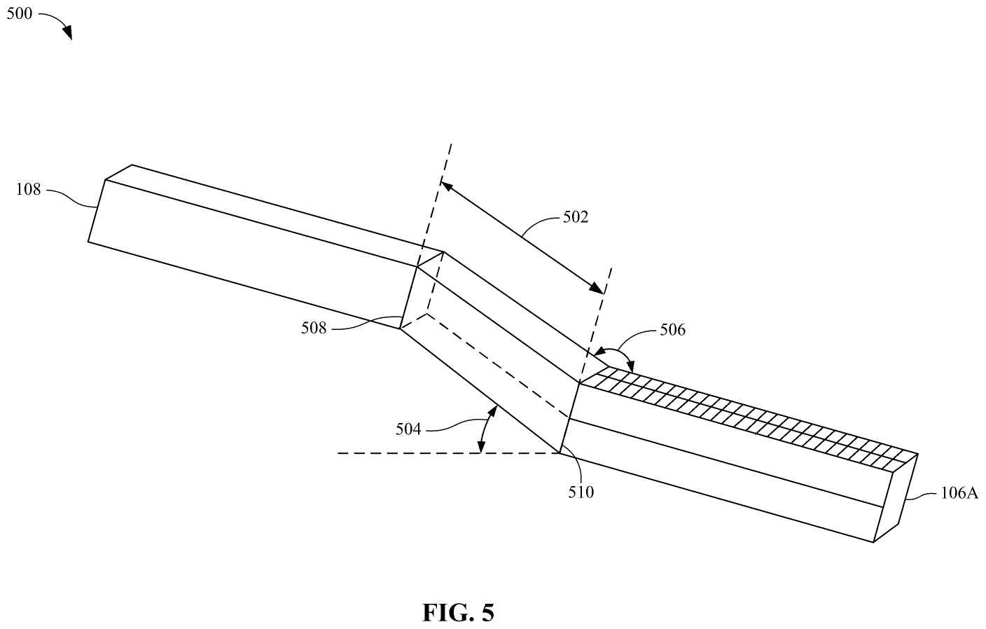

FIG. 5 is an exemplary scenario 500 that depicts the second set of parameters 204B. With reference to FIG. 5, there is shown an exemplary orientation of the docking station 108 and the first solar panel 106A. FIG. 5 is explained in conjugation with elements of FIG. 1, FIG. 2, FIG. 3, and FIG. 4. With reference to FIG. 5, there is further shown, a first portion 502, a second portion 504, and a third portion 506. The first portion 502, the second portion 504, and the third portion 506 may be associated with the second set of parameters 204B.

In an embodiment, the first portion 502 may be indicative of the gap between a docking station frame 508 associated with the docking station 108 and a module edge 510 associated with the first solar panel 106A. In an embodiment, the system 102 may be configured to determine the proposed value for the gap between the docking station frame 508 and the module edge 510 based on the first set of parameters 204A. In an example, the first portion 502 may be measured in millimeters. For example, the first portion 502 is ‘150 millimeters’ indicative of the perpendicular gap (perpendicular distance) between the docking station frame 508 and the module edge 510 is ‘150 millimeters’. In an embodiment, the first portion 502 may be used to determine the length of a connecting structure (such as a bridge) between the docking station 108 and the first solar panel 106A.

In an embodiment, the second portion 504 may be indicative of the design slope between the docking station frame 508 and the module edge 510. In an embodiment, the system 102 may be configured to determine the proposed value for the design slope between the docking station frame 508 and the module edge 510 based on the first set of parameters 204A. The design slope between the docking station frame 508 and the module edge 510 may be indicative of an inclination or an angle between the docking station 108 and at least one solar panel of the set of solar panels of the PV power plant 106. The at least one solar panel of the set of solar panels may be the solar panel that may be adjacent to the docking station 108 (for example, the first solar panel 106A). In an example, the second portion 504 may be measured in degrees. For example, the second portion 504 is ‘45’ degrees clockwise from horizontal or ground level indicative of the design slope between the docking station frame 508 and the module edge 510. In an embodiment, the second portion 504 may be used to determine an angle of the connecting structure between the docking station 108 and the first solar panel 106A.

In an embodiment, the third portion 506 may be indicative of the maximum angular difference between the docking station 108 and the adjacent solar panel of the first tracker (for example, the first solar panel 106A). The maximum angular difference between the docking station 108 and the adjacent solar panel of the first tracker may be indicative of the maximum allowable angular variation between the docking station 108 and the adjacent solar module (for example, the first solar panel 106A). The adjacent solar module may be mounted on the first tracker within the PV power plant 106. In an embodiment, the third portion 506 may be measured in degrees. For example, the third portion ‘506’ is 150 degrees anticlockwise from the surface level of the first solar panel 106A indicative of the maximum angular difference between the docking station 108 and the first solar panel 106A. In an embodiment, the third portion 506 may be used to determine the maximum possible angle at which the docking station 108 may be placed with respect to the first solar panel 106A.

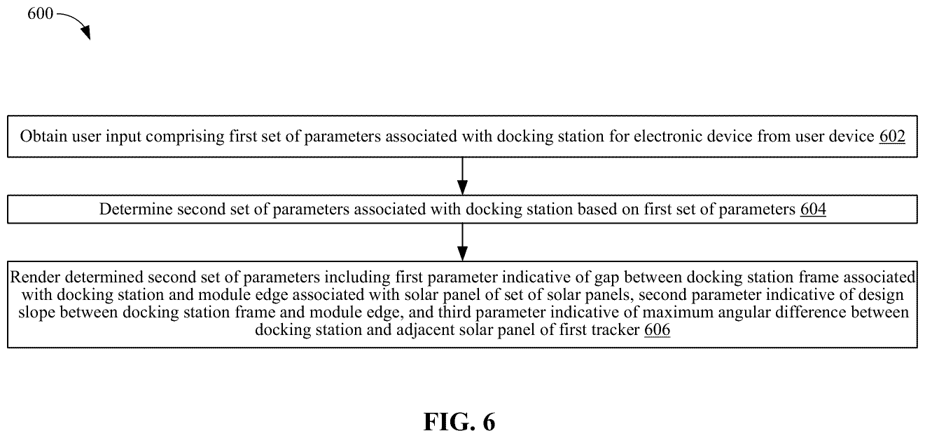

FIG. 6 illustrates a method flowchart for the determination of parameters for the set up of docking stations for electronic devices used in PV power plants, in accordance with an embodiment of the disclosure. FIG. 6 is explained in conjugation with elements of FIG. 1, FIG. 2, FIG. 3, FIG. 4, and FIG. 5. With reference to FIG. 6, there is shown a flowchart 600. The operations of the exemplary method may be executed by any computing system, for example, by the system 102 of FIG. 1 or the processor 202 of FIG. 2. The operations of the flowchart 600 may start at 602.

At 602, the user input may be obtained from the user device 104. In an embodiment, the system 102 may be configured to obtain the user input from the user device 104. The user input may include the first set of parameters 204A associated with the docking station 108 for the electronic device 110. The electronic device 110 may be used to clean the set of solar panels (the first solar panel 106A, the second solar panel 106B, up to the Nth solar panel 106N) of the PV power plant 106. In at least one embodiment, the processor 202 may be configured to obtain the user input from the user device 104. Details about obtaining the user input are provided, for example, in FIG. 3.

At 604, the second set of parameters 204B may be determined based on the first set of parameters 204A. In an embodiment, the system 102 may be configured to determine the second set of parameters 204B based on the first set of parameters 204A. The second set of parameters 204B may be associated with the docking station 108. In at least one embodiment, the processor 202 may be configured to determine the second set of parameters 204B based on the first set of parameters 204A. Details about the determination of the second set of parameters 204B are provided, for example, in FIG. 3.

At 606, the determined second set of parameters 204B may be rendered. In an embodiment, the system 102 may be configured to render the determined second set of parameters 204B. The second set of parameters 204B may include the first parameter 402A indicative of the magnitude of the gap between the docking station frame associated with the docking station 108 and the module edge associated with the first solar panel 106A of the set of solar panels, the second parameter 402B indicative of magnitude of the design slope between the docking station frame and the module edge, and the third parameter 402C indicative of magnitude of the maximum angular difference between the docking station 108 and the adjacent solar panel of the first tracker. In at least one embodiment, the processor 202 may be configured to render the determined second set of parameters 204B. Details about the rendering of the second set of parameters 204B are provided, for example, in FIG. 3.

Accordingly, blocks of the method flowchart 600 support combinations of means for performing the specified functions and combinations of operations for performing the specified functions. It will also be understood that one or more blocks of the method flowchart 600, and combinations of blocks in the method flowchart 600, can be implemented by special-purpose hardware-based computer systems which perform the specified functions, or combinations of special-purpose hardware and computer instructions.

Alternatively, the system 102 may comprise means for performing each of the operations described above. In this regard, according to an example embodiment, examples of means for performing operations may comprise, for example, the processor and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

What is claimed:

1. A system comprising:
a memory to store computer-executable instructions; and
one or more processors coupled to the memory, wherein the one or more processors are configured to:
obtain, from a user device, user input comprising a first set of parameters associated with a docking station for an electronic device, wherein the electronic device is used to clean a set of solar panels of a photovoltaic (PV) power plant;
determine a second set of parameters associated with the docking station based on the first set of parameters; and
render the determined second set of parameters including a first parameter indicative of a gap between a docking station frame associated with the docking station and a module edge associated with a solar panel of the set of solar panels, a second parameter indicative of a design slope between the docking station frame and the module edge, and a third parameter indicative of a maximum angular difference between the docking station and an adjacent solar panel of a first tracker.

2. The system of claim 1, wherein the one or more processors are configured to:
determine a set of instructions for installation of the docking station based on the second set of parameters, wherein the set of instructions is associated with the installation of the docking station; and
transmit the set of instructions to an installation device.

3. The system of claim 1, wherein the one or more processors are configured to:
determine navigation instructions for the electronic device based on the second set of parameters, wherein the navigation instructions are associated with cleaning of the set of solar panels of the PV power plant;
transmit the navigation instructions to the electronic device; and
control the electronic device based on the navigation instructions.

4. The system of claim 1, wherein the electronic device comprises of at least one of a track-based robot, a crawler robot, a drone-based robot, a water-based robot, a dry dust removal robot, a modular cleaning robot, an automated scrubber robot, or a vacuum cleaner robot.

5. The system of claim 1, wherein the second set of parameters is determined using an application of one or more mathematical operations on the first set of parameters.

6. The system of claim 1, wherein the first set of parameters comprises of: a first parameter indicative of the gap between the docking station frame and the module edge, a second parameter indicative of the design slope between the docking station frame and the module edge, a third parameter indicative of a maximum vertical offset of the docking station and an adjacent solar panel of the first tracker, a fourth parameter indicative of a maximum horizontal offset of the docking station and the adjacent solar panel of the first tracker, a fifth parameter indicative of a rotational angular misalignment of the first tracker at a motor level, a sixth parameter indicative of a rotational angular misalignment of the first tracker at a torque tube level, a seventh parameter indicative of a total rotational angular misalignment of the first tracker, and an eighth parameter indicative of a maximum total angular misalignment between the docking station and the adjacent solar panel of the first tracker, wherein the first tracker associated with the PV power plant tracks a movement of sun in one axis.

7. The system of claim 6, wherein the adjacent solar panel of the first tracker is indicative of the solar panel associated with the first tracker adjacent to the docking station.

8. A method comprising:
obtaining, from a user device, user input comprising a first set of parameters associated with a docking station for an electronic device, wherein the electronic device is used to clean a set of solar panels of a photovoltaic (PV) power plant;
determining a second set of parameters associated with the docking station based on the first set of parameters; and
rendering the determined second set of parameters including a first parameter indicative of a gap between a docking station frame associated with the docking station and a module edge associated with a solar panel of the set of solar panels, a second parameter indicative of a design slope between the docking station frame and the module edge, and a third parameter indicative of a maximum angular difference between the docking station and an adjacent solar panel of a first tracker.

9. The method of claim 8, further comprising:
determining a set of instructions for installation of the docking station based on the second set of parameters, wherein the set of instructions is associated with the installation of the docking station; and
transmitting the set of instructions to an installation device.

10. The method of claim 8, further comprising:
determining navigation instructions for the electronic device based on the second set of parameters, wherein the navigation instructions are associated with cleaning of the set of solar panels of the PV power plant;
transmitting the navigation instructions to the electronic device; and
controlling the electronic device based on the navigation instructions.

11. The method of claim 8, wherein the electronic device comprises of at least one of a track-based robot, a crawler robot, a drone-based robot, a water-based robot, a dry dust removal robot, a modular cleaning robot, an automated scrubber robot, or a vacuum cleaner robot.

12. The method of claim 8, wherein the second set of parameters is determined using an application of one or more mathematical operations on the first set of parameters.

13. The method of claim 8, wherein the first set of parameters comprises of: a first parameter indicative of the gap between the docking station frame and the module edge, a second parameter indicative of the design slope between the docking station frame and the module edge, a third parameter indicative of a maximum vertical offset of the docking station and an adjacent solar panel of the first tracker, a fourth parameter indicative of a maximum horizontal offset of the docking station and the adjacent solar panel of the first tracker, a fifth parameter indicative of a rotational angular misalignment of the first tracker at a motor level, a sixth parameter indicative of a rotational angular misalignment of the first tracker at a torque tube level, a seventh parameter indicative of a total rotational angular misalignment of the first tracker, and an eighth parameter indicative of a maximum total angular misalignment between the docking station and the adjacent solar panel of the first tracker, wherein the first tracker associated with the PV power plant tracks a movement of sun in one axis.

14. The method of claim 13, wherein the adjacent solar panel of the first tracker is indicative of the solar panel associated with the first tracker adjacent to the docking station.

15. A computer programmable product comprising a non-transitory computer readable medium having stored thereon computer executable instructions, which when executed by one or more processors, cause the one or more processors to conduct operations, comprising:
obtaining, from a user device, user input comprising a first set of parameters associated with a docking station for an electronic device, wherein the electronic device is used to clean a set of solar panels of a photovoltaic (PV) power plant;
determining a second set of parameters associated with the docking station based on the first set of parameters; and
rendering the determined second set of parameters including a first parameter indicative of a gap between a docking station frame associated with the docking station and a module edge associated with a solar panel of the set of solar panels, a second parameter indicative of a design slope between the docking station frame and the module edge, and a third parameter indicative of a maximum angular difference between the docking station and an adjacent solar panel of a first tracker.

16. The computer programmable product of claim 15, the operations further comprising:
determining a set of instructions for installation of the docking station based on the second set of parameters, wherein the set of instructions is associated with the installation of the docking station; and
transmitting the set of instructions to an installation device.

17. The computer programmable product of claim 15, the operations further comprising:
determining navigation instructions for the electronic device based on the second set of parameters, wherein the navigation instructions are associated with cleaning of the set of solar panels of the PV power plant;
transmitting the navigation instructions to the electronic device; and
controlling the electronic device based on the navigation instructions.

18. The computer programmable product of claim 15, wherein the electronic device comprises of at least one of a track-based robot, a crawler robot, a drone-based robot, a water-based robot, a dry dust removal robot, a modular cleaning robot, an automated scrubber robot, or a vacuum cleaner robot.

19. The computer programmable product of claim 15, wherein the second set of parameters is determined using an application of one or more mathematical operations on the first set of parameters.

20. The computer programmable product of claim 15, wherein the first set of parameters comprises of: a first parameter indicative of the gap between the docking station frame and the module edge, a second parameter indicative of the design slope between the docking station frame and the module edge, a third parameter indicative of a maximum vertical offset of the docking station and an adjacent solar panel of the first tracker, a fourth parameter indicative of a maximum horizontal offset of the docking station and the adjacent solar panel of the first tracker, a fifth parameter indicative of a rotational angular misalignment of the first tracker at a motor level, a sixth parameter indicative of a rotational angular misalignment of the first tracker at a torque tube level, a seventh parameter indicative of a total rotational angular misalignment of the first tracker, and an eighth parameter indicative of a maximum total angular misalignment between the docking station and the adjacent solar panel of the first tracker, wherein the first tracker associated with the PV power plant tracks a movement of sun in one axis.
